(19) United States
(12) Patent Application Publication
(10) Pub. No.: US 2017/0094721 A1
(43) Pub. Date: Mar. 30, 2017

(54) Sip N Soothe

(71) Applicants: Cheryl E. Moore, Stonewall, LA (US); Robert W. Atwood, Stonewall, LA (US)

(72) Inventors: Cheryl E. Moore, Stonewall, LA (US); Robert W. Atwood, Stonewall, LA (US)

(21) Appl. No.: 14/677,492

(22) Filed: Apr. 2, 2015

(51) Int. Cl. H05B 1/02; F21V 33/00; B65D 81/18; B65D 1/02; A61J 9/00; B65D 41/02

(52) U.S. Cl. CPC H05B 1/0252; A61J 9/00; B65D 41/02; B65D 81/18; B65D 1/02; F21V 33/0024; H05B 2203/021; F21W 2111/00

(57) ABSTRACT

A baby's feeding bottle warmer comprising a bottle, a cylindrical enclosure provided with a clear sidewall with the sealed bottom end and an opening at the top, covered with the cap, capable of heating its contents at a certain constant temperature. The bottle also having a heating element embedded at the bottom end of the bottle, provided for effective heat distribution and accurate control of the temperature throughout the contents of a baby bottle. It is operated by the electrical power source and/or a battery.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention relates to bottle with warming devices and, more particularly, to a baby feeding bottle comprising of heating element. Specifically, this invention relates to a method of heating the contents of a baby feeding bottle, and a method of storage of the baby feeding bottle in a compressed and sterile state prior to use.

(2) Background of Invention

A feeding schedule for a baby typically includes feeding intervals between a minimum of about three hours and a maximum of about four hours. The majority of babies generally adapt to this schedule within a few weeks.

Naturally, the schedule intervals may be shifted to those most convenient for the parents. However, no matter what the schedule, night-time feeding is mandated by the baby's needs.

Most parents find it most convenient to prepare enough formula for a full day's feeding simply because it is easier at late night or early morning hours to simply heat a prepared bottle to avoid the late night/early morning steps of boiling the bottles for sterilization and thereafter filling the bottles with formula.

However, even with a prepared formula, it can be very frustrating listening to a baby cry while waiting for the bottle to warm. Furthermore, the baby's room or crib is typically not conveniently located to the kitchen refrigerator and stove/microwave where the bottle is prepared for feeding.

U.S. Pat. No. 5,397,031, issued Mar. 8, 1994, provides baby milk warmer. This device allows the warming of the bottle and a sensor that detects when heat is no longer needed. Such devices can be conveniently placed anywhere in the home such as in the nursery or the parent's bedside. Because parents are typically more mobile today traveling with their children and working outside of the home, the need for a portable, non-electrical device has arisen.

U.S. Pat. No. 3,931,494, issued Jan. 6, 1976, to Fisher and Spector, discloses a vessel incorporating a battery, heating coil, thermostat, and on-off switch. Fisher and Spector require that the bottom compartment containing the battery, thermostat and on-off switch have a screw-type closing mechanism to access the pivotable plug prongs corrected to the battery.

U.S. Pat. No. 5,208,896 A, issued May 4, 1993, to Alexander Katayev, provides an electrically warmed baby bottle and recharging system. The baby bottle is a container made of an electrically non-conductive material with a heating wire embedded in its walls. The electrically warmed baby bottle fits into a battery charger which is designed with plug prongs which enter the water-tight housing through self-sealing ports so as to recharge the battery.

Accordingly, a need remains for a warming or heating apparatus for feeding warm milk to the babies and the like.

The present invention provides convenient baby milk warmer, which enables the preparation of formula at the baby's bedside. Thus, a parent responding to the baby's crying request for food can conveniently comfort and soothe the baby while simultaneously preparing the baby formula for use.

As such, it may be appreciated that there continues to be a need for a new and improved milk warming or heating apparatus as set forth by the instant invention which addresses the problems of ease of use as well as effectiveness in construction in providing the baby feeding bottle for use in providing warm milk to the babies and in this respect, the present invention substantially fulfills this need.

### BRIEF SUMMARY OF THE INVENTION

In view of the foregoing disadvantages inherent in the known types of milk warming apparatus now present in the prior art, the present invention provides a baby's feeding bottle wherein the same provides for a heating element for warming milk to feed babies and use on process of various components employed in the procedure. As such, the general purpose of the present invention, which will be described subsequently in greater detail, is to provide a new and improved milk warming apparatus which has all the advantages of the prior art and none of the disadvantages.

Accordingly, it is a primary aspect of the present invention to provide a baby's feeding bottle, which heats the liquid inside the bottle to a certain constant temperature. For the purpose, temperature gauge is provided.

In another aspect, the present invention provides a feeding bottle that always have warm milk or bottle, ready for feeding, preferably during nights or while travelling.

It is yet another aspect of the present invention where the feeding bottle comprises the thermos bottle with clear transparent side walls, heating element, LED liht and micro USB port.

Additionally, the USB port provided in the present inventive product could be connected to electric source at home and/or to USB cord in the vehicle.

Further aspect of the present invention provides a baby bottle warmer that is portable, convenient to use, simple, and lightweight, the present invention provides a method and apparatus that utilizes a heating element that warms a baby bottle.

It is still another aspect of the present invention to provide a new and improved baby's feeding bottle which may be easily and efficiently manufactured and marketed.

It is a further aspect of the present invention to provide a new and improved baby's feeding bottle which is of a durable and reliable construction.

Other aspects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 depicts a perspective view of the baby's feeding bottle.

FIG. 2 depicts a perspective view of the baby's feeding bottle and also showing the heating element through the clear sidewall.

### DETAIL DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

In some preferred embodiments, the present invention provides a baby's feeding bottle which allows babies to always have warm bottles. The heating element is inbuilt in the feeding bottle, provided with the USB port, which could be connected to the power source. The inventive product provides comfort to the parent as they need not to get out of the bed during nights, to feed warm bottle to their babies. Also, the inventive product would prove to be beneficial during travel, as the provided USB port would be connected to the charging cord in the vehicle. Moreover, the feeding apparatus may also be operated by the batteries.

In further embodiment, the feeding bottle warms the liquid (milk or water) inside the bottle to a certain constant temperature for maximum hours. As the liquid attains the desired temperature, the LED light comes on, indicating the user thereof.

With reference now to the drawings, a new and improved baby's feeding bottle embodying the principles and concepts of the present invention are described herein.

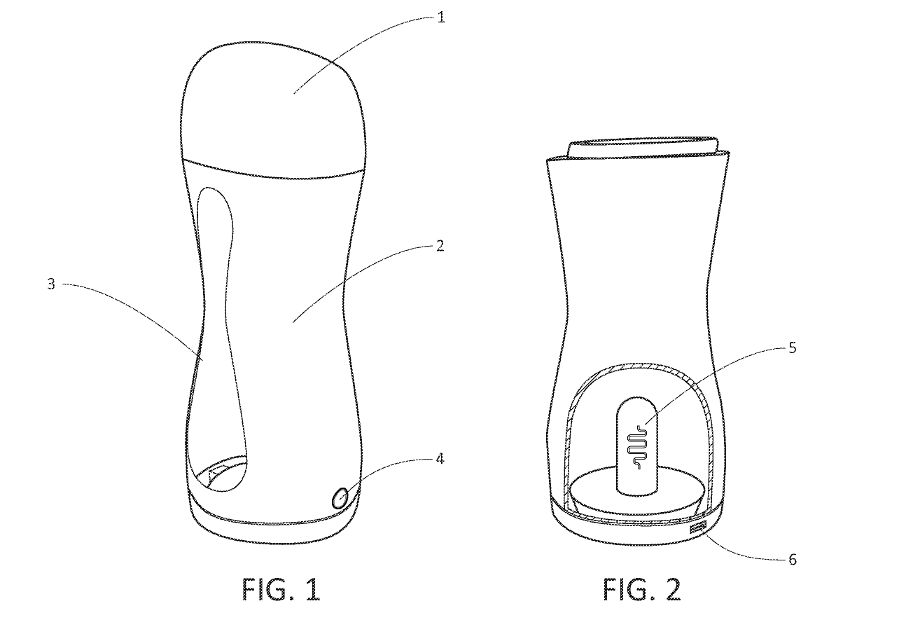

Referring to FIG. 1, an embodiment of the feeding bottle heating apparatus according to this invention is designated generally by the reference character. The overall assembly of the heating apparatus includes a generally cylindrical enclosure with a cap 1, is a thermos bottle 2 a clear sidewall 3, the LED light indicator 4 at the front end of the feeding bottle. The bottle 2 is covered by the cap 1, to keep the content of the bottle safe and hygiene.

Further embodiment discloses the another perspective view of the baby's feeding bottle as represented in FIG. 2, which comprises the cap, bottle with the clear sidewall to see through the bottle, intimating the amount of the milk or water remain inside the bottle. The feeding apparatus is particularly efficient in heating bottles including a heating element 5, which is inbuilt inside the bottle. At the rear bottom end, a micro USB port 6 is provided through which apparatus would be connected to the power source. The bottle is also operated by the battery.

In accordance with the invention, the bottle has a closed bottom wall and an opening at the upper end.

The heating element, as shown, is placed in between at the bottom end of the bottle.

In further embodiment, heating element, is covered by some plastic material or the like, such that it remain protected with the liquid (milk or water) which is to be warm inside the feeding apparatus, as shown in FIG. 2.

As may now be appreciated from the above description and reference to the accompanying drawings, the present invention provides a baby's feeding apparatus which may be utilized by the parents to store and further feed the warm milk to their babies, preferably during nights and/or while travelling.

It is to be understood that the above description is intended to be illustrative, and not restrictive. For example, the above-discussed embodiments may be used in combination with each other. Many other embodiments will be apparent to those of skill in the art upon reviewing the above description.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A baby's feeding bottle warmer for heating its contents at a certain constant temperature comprises:
a) a bottle with a clear sidewall, the sealed bottom end and an opening at the top, covered with the cap;
b) a heating element embedded at the bottom end of the bottle;
c) LED light indicator;
d) a battery; and
e) Micro USB port, which could be connected to the power source.

2. A baby's feeding bottle warmer of claim 1, wherein said bottle is a thermos.

3. A baby's feeding bottle warmer of claim 1, wherein said heating element heats the content to a certain constant temperature constantly.

4. A baby's feeding bottle warmer of claim 1, wherein said heating element provides effective heat distribution and accurate control of the temperature throughout the contents of a baby bottle.

5. A baby's feeding bottle warmer of claim 1, wherein said LED light comes on, indicating when the liquid attains the desired temperature.

6. A baby's feeding bottle warmer of claim 1, wherein said micro USB port is connected to the electrical power source.

7. A baby's feeding bottle warmer of claim 1, wherein said micro USB port is plugged to the charging cord in a vehicles.
